(19) United States
(12) Patent Application Publication
(10) Pub. No.: US 2013/0179676 A1
(43) Pub. Date: Jul. 11, 2013

(54) CLOUD-BASED HARDWARE SECURITY MODULES

(71) Applicant: Imation Corp., Oakdale, MN (US)

(72) Inventor: Laurence Hamid, Ottawa (CA)

(73) Assignee: Imation Corp., Oakdale, MN (US)

(21) Appl. No.: 13/723,877

(22) Filed: Dec. 21, 2012

Related U.S. Application Data
(60) Provisional application No. 61/581,348, filed on Dec. 29, 2011.

(51) Int. Cl. H04L 29/06; H04L 9/08

(52) U.S. Cl. CPC H04L 63/0471; H04L 9/08
USPC 713/150

(57) ABSTRACT

A cloud-based hardware security device (HSM) providing core security functions of a physically controlled HSM, such as a USB HSM, while allowing user access within the cloud and from a user device, including user devices without input ports capable of direct connection to the HSM. The HSMs can be connected to multi-HSM appliances on the organization or user side of the cloud network, or on the cloud provider side of the cloud network. HSMs can facilitate multiple users, and multi-HSM appliances can facilitate multiple organizations.

### CROSS-REFERENCE TO RELATED APPLICATIONS

This application claims priority to U.S. Provisional Application No. 61/581,348, filed Dec. 29, 2011, entitled CLOUD-BASED HARDWARE SECURITY MODULES, the entirety of which is incorporated by reference herein.

### BACKGROUND

Regardless of the distribution model, security is a critical concern for most device users and organizations. There are a number of security devices available for ensuring data privacy, such as access passwords, biometric readers, hardware security tokens, digital certificates, encryption/decryption, secure socket communications, etc. For example, a user may be required to plug in a physical universal serial bus (USB) security device into a USB port on a public, private, or semi-public terminal station to gain access to that station and/or any distributed data/services accessible through that station. One of the security features of a physical USB token is physical ownership of the token; that is, only a user in physical possession of the hardware token can access the data and services. Physical ownership can by layered with access codes, biometric readings, etc., to ensure the proper user is in physical ownership of the device.

These physical security tokens can include a number of functions, such as dedicated security processors, encryption/decryption accelerators, private keys, biometric readers, etc. They may essentially be a wholly or near wholly contained security solution, such that when a user plugs the token in, internal hardware and/or software takes care of all the security measures, prompting the user for any needed passcodes, etc. The security tokens include a large set of security features currently used in the market.

### SUMMARY

Exemplary embodiments of the present disclosure can include a system for cloud-based hardware security modules, including a physical security device with a processor. The processor can be configured to create a secure connection to a user device across a multi-user network, and decrypt data accessed by the user device over the multi-user network. In other exemplary embodiments, the secure connection can be independent of any transport protocol. Further, the physical security device can include a connector of a first type configured to connect to a reciprocal input port of the first type, and wherein the physical device does not include an input port of the first type. That connector type can be a USB connector. In certain exemplary embodiments, the physical device can be associated with multiple users.

Certain exemplary embodiments can also include an appliance configured to receive a plurality of physical security devices. Each physical security device can be associated with multiple users, including each processor being configured to create multiple secure connections, including at least one per user. Further, each physical security device can be associated with only one organization and the multiple users associated with a particular physical security device are all within the only one organization, and a plurality physical security devices can be associated with a single organization.

Another exemplary embodiment of the present disclosure includes a method for providing hardware security modules over a multi-user network. The exemplary method can include providing shared resources over a multi-user network to multiple users, connecting multiple hardware security modules to the shared resources, wherein each hardware security module is associated with at least one user, establishing a secure connection between the at least one user and an associated hardware security module, and providing encrypted data to the at least one user, wherein the data can only be decrypted with keys stored on the associated hardware security module.

In other exemplary embodiments the provided shared resources can be shared among multiple organizations requiring strict data access separation such that each organization can only access data associated with that particular organization. In other exemplary embodiments, each hardware security module can be associated with only one organization and at least one user within the only one organization. Further, a plurality of hardware security modules can be associated with the only one organization. Exemplary embodiments can also provide management tools to a user associated with a particular hardware security device to directly configure the particular hardware security device.

Other exemplary embodiments can include non-transitory computer readable storage mediums having a program embodied thereon, the program executable by a processor to perform a method for managing data in a non-volatile memory system according to any of the other or additional exemplary embodiments.

### BRIEF DESCRIPTION OF THE DRAWING

FIG. 1 depicts a diagram of an embodiment of a cloud-based secure connection between a client application and a hardware security module (HSM).

FIG. 2 depicts a diagram of an embodiment of a multi-user HSM.

FIG. 3 depicts a diagram of an embodiment of a system including multi-HSM appliances.

FIG. 4 depicts a diagram of a cloud-based connection on an existing client platform to an HSM.

FIG. 5 illustrates a flowchart of an example of a process for providing HSMs on a cloud-based network.

FIG. 6 illustrates a block diagram of an example system according to another exemplary embodiment of the present invention.

FIG. 7 illustrates a block diagram of a security system utilizing key cryptography.

FIG. 8 illustrates a block diagram of a cloud-based security system utilizing a key token.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing preferred and exemplary embodiments of the disclosure. It should be understood that various changes may be made in the function and arrangement of elements without departing from the spirit and scope of the invention as set forth in the appended claims.

Devices (e.g., hardware) and data (e.g., software code and stored user data) are increasingly being designed for and/or integrated into a cloud paradigm, which can include maximizing mobility at the user level and maximizing distribution at the network level. Devices, such as smart-phones, tablets, etc., are increasingly designed for remote access to central databases and software services, often lacking physical (e.g., wired) input ports, save for a dual purpose power recharge and data synchronization port, which is often used as just a power recharge port. Wireless synchronization and communication between the device and distributed data storage and network-based software services may perform all or a majority of a device's data transfer requirements. Very few devices smaller than a net-book (e.g., an ultra small laptop) include a standard universal serial bus (USB) port, and their intended ultra-mobile use may not be suitable for requiring an externally attached device (e.g., a USB drive device).

Exemplary USB portable security devices can enhance the security of information systems. They can include strong authentication tokens, portable encrypted storage devices, and public key infrastructure (PKI) tokens, among other features. An exemplary cloud infrastructure can allow users to access their applications and data almost anywhere and from almost any type of platform (e.g., Windows, Mac OS, Android, iPhone OS, etc.). Many of these applications can require strong security, but cannot use existing USB security devices. This can require the application security to be reduced across every platform, since it ordinarily is not feasible to use the same application with a hardware security module on a first platform (e.g., a PC) while not using it on another platform (e.g., a tablet), since there may be key material that is only contained within the hardware security module (HSM). As such, there remains a need for the benefits on security hardware, while allowing highly mobile devices to remain highly mobile.

Exemplary embodiments of the present disclosure can include a system of hardware connectable (e.g., USB) security devices for use as hardware security modules or tokens in cloud computing. Certain exemplary embodiments can re-purpose existing hardware security devices designed to interface with larger terminals (e.g., personal commuters (PCs)) to now provide the same benefits to lighter devices in a cloud computing architecture, e.g., those without an input port capable of accepting the hardware modules.

Hereinafter hardware security devices may be referred to specifically as a USB security device, which is meant only as one exemplary embodiment, while any number of other formats, platforms, and/or device arrangements are also possible. USB, as used herein as an exemplary embodiment, is one exemplary connection protocol known in the art, including USB connectors and USB ports, but any number of other connection designs are also possible, including mini-USB, micro-USB, firewire, eSATA (i.e. external Serial Advanced Technology Attachment), Ethernet, and any number of other known connector designs, and/or a new, custom, and/or proprietary connection design, either wired or wireless (e.g., Radio Frequency (RF), near field, Bluetooth, infrared (IR), etc.), can be used in other exemplary embodiments.

To make exemplary USB security devices useful for cloud computing and cloud devices, the USB security devices should be accessible from almost anywhere and on almost any platform. Further, the devices should be easily scalable to leverage a primary benefit of the cloud paradigm, e.g., scalability through seamless provisioning of cloud resources. One exemplary aspect of scalability can be obtained by supporting multiple users on a single device, each user having an individual identity, authentication methods, keys, etc. Another exemplary aspect of scalability can be obtained by allowing multiple security devices on a single appliance. This appliance can be a known device, such as a USB hub, server, PC, etc., or can be a custom built device, specifically designed for accepting a plurality of security devices. The appliance itself can be scalable, with several connectable to a network for one or more customers. The scalable appliance based security devices (“Cloud HSMs”) can be available to cloud computing by putting a server on the appliance and a software component on the client platforms to enable access to the Cloud HSM. Multiple secure channels (e.g., one or more per user) can be served by one such appliance.

Exemplary embodiments can include a secure communication channel, which can be mutually authenticated, allowing applications to operate and interact with an exemplary Cloud HSM in a similar way and with similar security as if the USB security device was directly plugged into the local platform. Exemplary embodiments can therefore enable strong user-centric authentication, access control, and key management, similar to a physical USB security device, without requiring physical control of the USB device. The exemplary USB security devices can offer several strong security features, such as FIPS Level 3 validated hardware security (a security specification by the Federal Information Processing Standard), hardware encryption for storage, hardware acceleration of public key operations, secure storage for keys, strong user authentication, enterprise grade management, accessibility almost anywhere from almost any platform, applicable to SaaS, PaaS, or IaaS (i.e. Software, Platform, or Infrastructure: as a Service) service models, support for on-premises or off-premises hosting, and/or being fully managed by cloud customers.

Exemplary embodiments of the present invention can include a security processor that has a FIPS approved key agreement scheme that allows anonymous, device authenticated, or mutually authenticated encrypted communication sessions to be established between the exemplary device and an external entity such as a client application. These exemplary encrypted sessions can allow authentication credentials, keys, commands, results of security functions, and data to be transmitted securely. The secure channel can operate independently of any transport protocol and therefore can traverse any intermediary communication link (e.g., USB, Hypertext Transfer Protocol Secure (i.e. HTTPS), etc.) without any party in between able to view the messages.

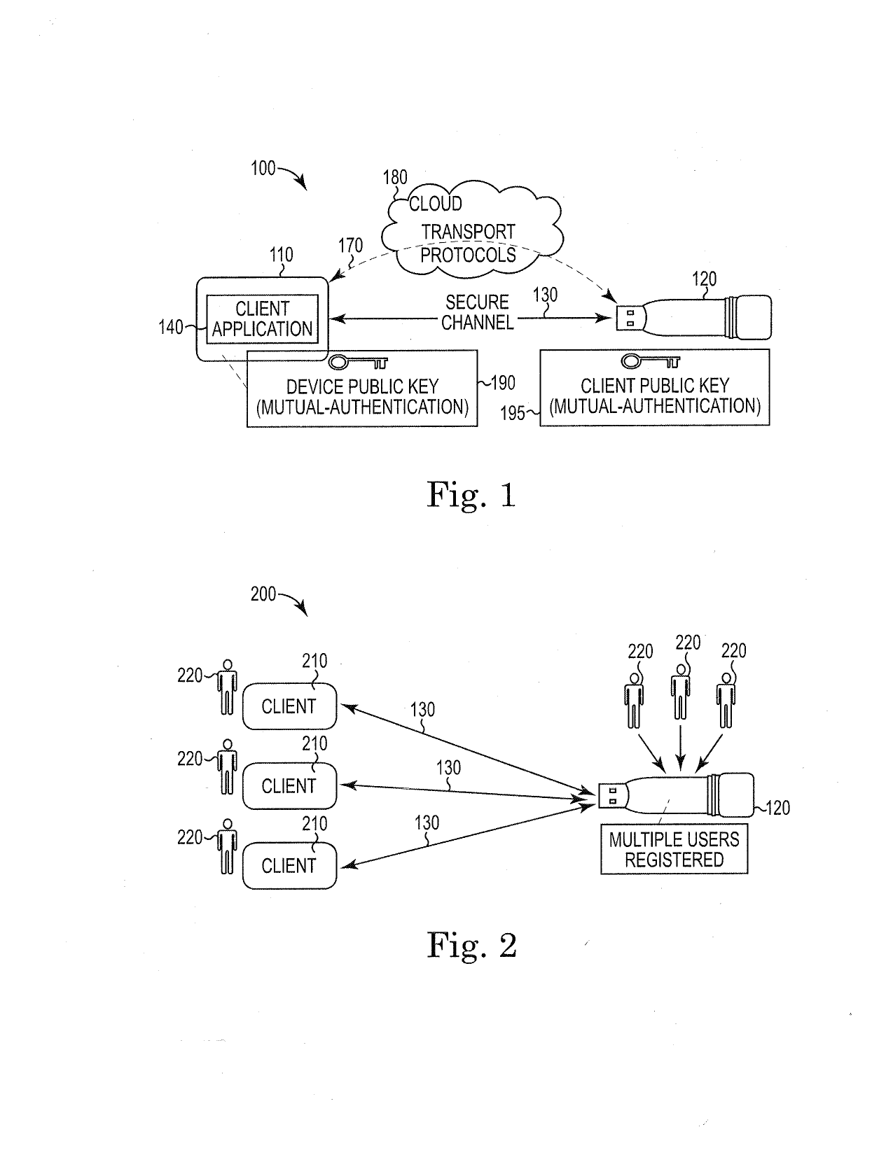

FIG. 1 illustrates a secure channel to cloud-based HSM system 100 for client machine 110 and remote device 120. This exemplary mutually authenticated secure channel 130 can allow a remote device 120 to be connected to a client application 140, e.g., as if it were directly plugged into the client machine 110, and can be provided without any substantial decrease in security. This can make it possible to host exemplary security devices 120 via transport protocols 170 in the cloud 180, effectively making them Cloud-based Hardware Security Modules 120. Furthermore, multiple secure channels 130 can be active simultaneously, which means a device 120 can be virtually connected and providing security services to multiple clients 210 at the same time (FIG. 2).

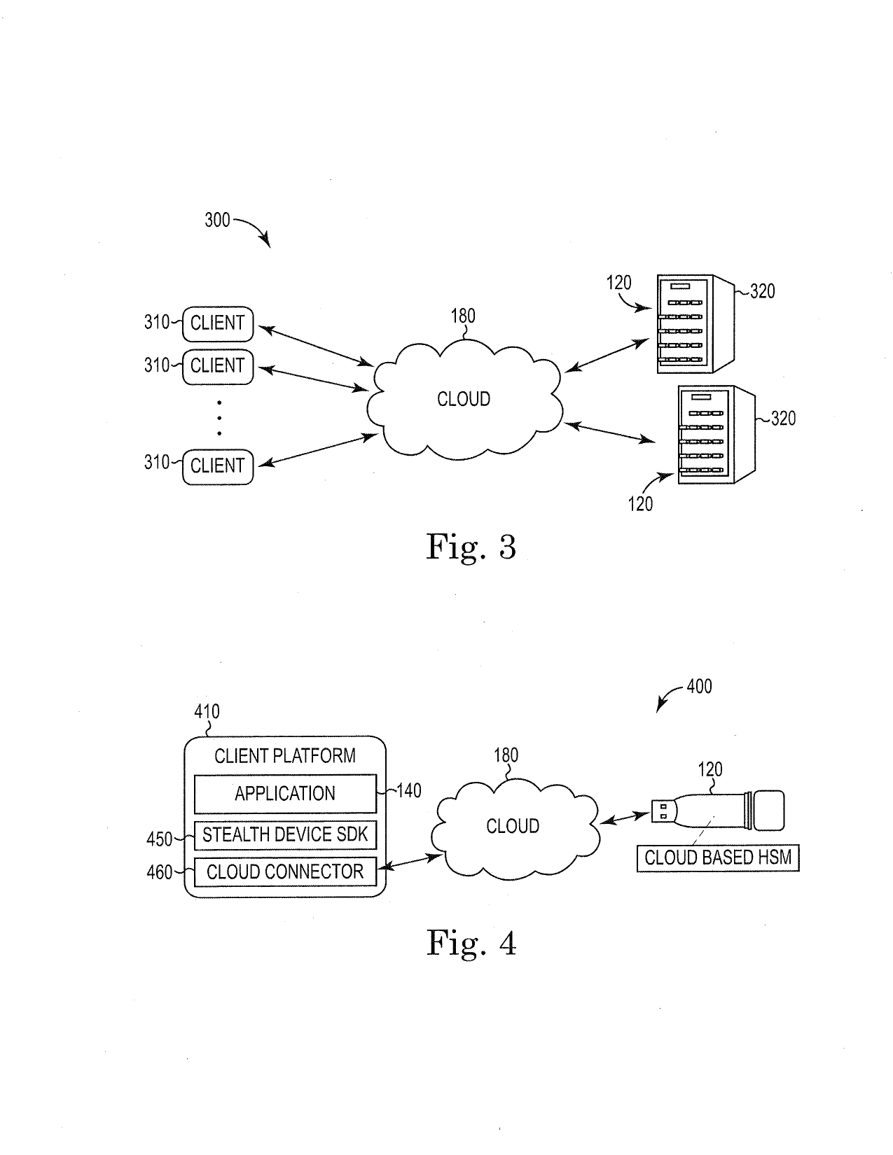

The exemplary embodiments can support multiple user identities, each with its own authentication methods. Each multi-user device 120 can be configured to serve any number of clients 210, from a single user 220 to hundreds of users 220, or any number therebetween. Preferably, exemplary embodiments can serve several users 220 (e.g., ten) to several scores of users 220 (e.g., up to about sixty-three) or any number therebetween. Since multiple secure channels 130 can be maintained simultaneously by one device 120, it is also possible for a single device 120 to provide security services for multiple users 220 simultaneously. One user 220 need not wait for the other to log out in order to perform their own operations. FIG. 3 illustrates a multiple user design, e.g., with multiple concurrent client sessions 310.

The exemplary embodiments of the present disclosure can provide hardware acceleration of public key operations. This can mean that system 100, 200, or 300 can perform fast key generation and fast signing or decryption operations. This performance is preferable when a single device 120 is to serve multiple simultaneous sessions for applications 140 such as an identity provider (e.g., signing Security Assertion Markup Language (SAML) tokens for federated identity) or PKI based encryption, and/or digital signatures for documents and email.

Exemplary embodiments of the present disclosure can include hardware isolation of device public keys 190 and client public keys 195, or other public or private keys, data, and authentication, which can provide an exemplary basis for strong security. One exemplary benefit of this, e.g., in the context of cloud computing, is that it can offer customers guaranteed isolation of their security functions from other customers that may even share the same tenancy (e.g., the same physical disk array etc.). In certain exemplary embodiments, once a customer takes control of an exemplary device 120, it can be that no other entity can use it or even recycle it. In a cloud environment 180, hardware devices 120 can then safely exist physically side by side, yet remain completely dedicated to different cloud customers.

Exemplary embodiments of the present disclosure can provide added scalability by being able to support multiple users 220 on a single device 120, and enabling multi-device appliances 320 that can support a plurality of single devices 120. For example, one exemplary appliance 320 can support up to thirty-six USB devices 120 simultaneously, or any number of other devices 120 in other exemplary embodiments. Depending on the application, a single appliance 320 could then support more than 1,000 users 220, e.g., if each device 120 supported twenty-eight users 220, and the appliance 320 supported thirty-six devices 120, then the appliance 320 could support 1,008 users 220. These exemplary 1,000+ users 220 could exist across, e.g., up to thirty-six different cloud customers (e.g., different companies, groups, families, organizations, schools, etc.). Other appliances 320 could include support for other device quantities. FIG. 3 illustrates multiple clients 310 connected via a cloud 180 to multiple appliances 320, each having multiple security devices 120.

Architecturally speaking integration with a Cloud HSM 120 can be implemented either on the client platform 410, or on the back-end, e.g., depending on the type of cloud application and service model being used. Certain exemplary embodiments can include integration on the client platform 410, which can be done transparently at the communication layer of the device SDK 450 (e.g., as illustrated in FIG. 4, with platform 410 including cloud connector 460). This architecture 400 can have the advantage that it can be completely transparent to the application 140 whether a device is locally connected or whether it is a Cloud-based HSM 120.

Other exemplary embodiments can include integration on the back-end. Whether the cloud deployment is on-premises or off-premises organizations can manage their own devices with various management tools. For example, organizations can define users, authentication, usage and rescue policies. Management can be performed without a need to handle a physical device even though a physical device (or at least part of one) can be provisioned by the process. Existing management software can be used, new software can be used, or existing software can be modified to facilitate cloud-based management of the security devices. Security devices can also include the backup/archival of key material and/or data, in the event of device failures. For example, BlueKoN® or other protocols can be used as a way of providing trusted hardware backups and cloning of critical key material within exemplary security devices, e.g., with m-of-n administrative authentication.

Exemplary embodiments of Cloud HSMs can include using the exemplary Cloud HSMs as PKI tokens 120. Organizations and/or users can then deploy any number of security functions, including, e.g., 2-Factor certificate based authentication for workstation, virtual private network (VPN) and single sign-on (SSO) logins, digital signatures for email and document signing, and/or desktop to desktop email encryption. The exemplary PKI capabilities of exemplary Cloud HSMs 120 make them well-suited for strong user authentication for federated identity. Here the devices can be used to securely store identity claims and digitally sign SAML tokens in addition to providing strong authentication of the user. In certain exemplary embodiments, strong authentication can include the use of certificates and public key cryptography to assure identity claims for relying parties with or without the use of passwords.

Certain exemplary embodiments can include private encrypted storage in the cloud 180, which could be done in any number of ways. One exemplary method can be to use the Cloud HSMs 120 as the actual storage devices. Another exemplary method can be to use the Cloud HSMs 120 as secure key stores. In either or both exemplary methods, user authentication can unlock the use of the encryption key and the keys (e.g., 190, 195, or other public or private keys) can then be kept in control of the cloud user. As a secure key store, an exemplary Cloud HSM 120 could either encrypt the data in an on-demand fashion (e.g., plain text in and cipher text out), or it could supply a key 190, 195, etc. to the local client 210, 310 which would do the encryption locally. Due to throughput limitations and minimizing network traffic, on-demand encryption may preferably be used for smaller encryption needs (e.g., email decryption or digital signing), but it can have significant security advantages over supplying a key 190, 195, etc. to the client system 110 or platform 410.

Moving USB security devices 120 to the cloud can be counter-intuitive, as it can cause the loss of token ownership and in some embodiments, a loss of biometric authentication options. With a device in the cloud, it can become a target for attack and exemplary embodiments of the present disclosure can counter this effect; for example, users can be required or encouraged to provide greater protection of their device passwords. To further mitigate the risks, greater emphasis can be placed on the ability to trust a client machine. A mutually authenticated secure channel may be only effective if the client end point has not been compromised. Users or organizations can be provided the ability to control which endpoints are allowed to connect to a device. Further, enhancements to password authentication may also be required and/or encouraged, such as notifications to a user's smart phone or other device 110 or platform 410 when an attempt is being made to connect to an associated Cloud HSM 120, or the usage of the smart phone as a second factor of authentication.

Device failures can occur but this should not be allowed to cause loss of keys (e.g., 190, 195, or other public or private keys), as this can cause the loss of customer data to be permanent in certain exemplary embodiments. The replication, backup, and recovery of device keys 190, 195, etc., and the re-provisioning of replacement devices 120 can be made part of the cloud environment 180.

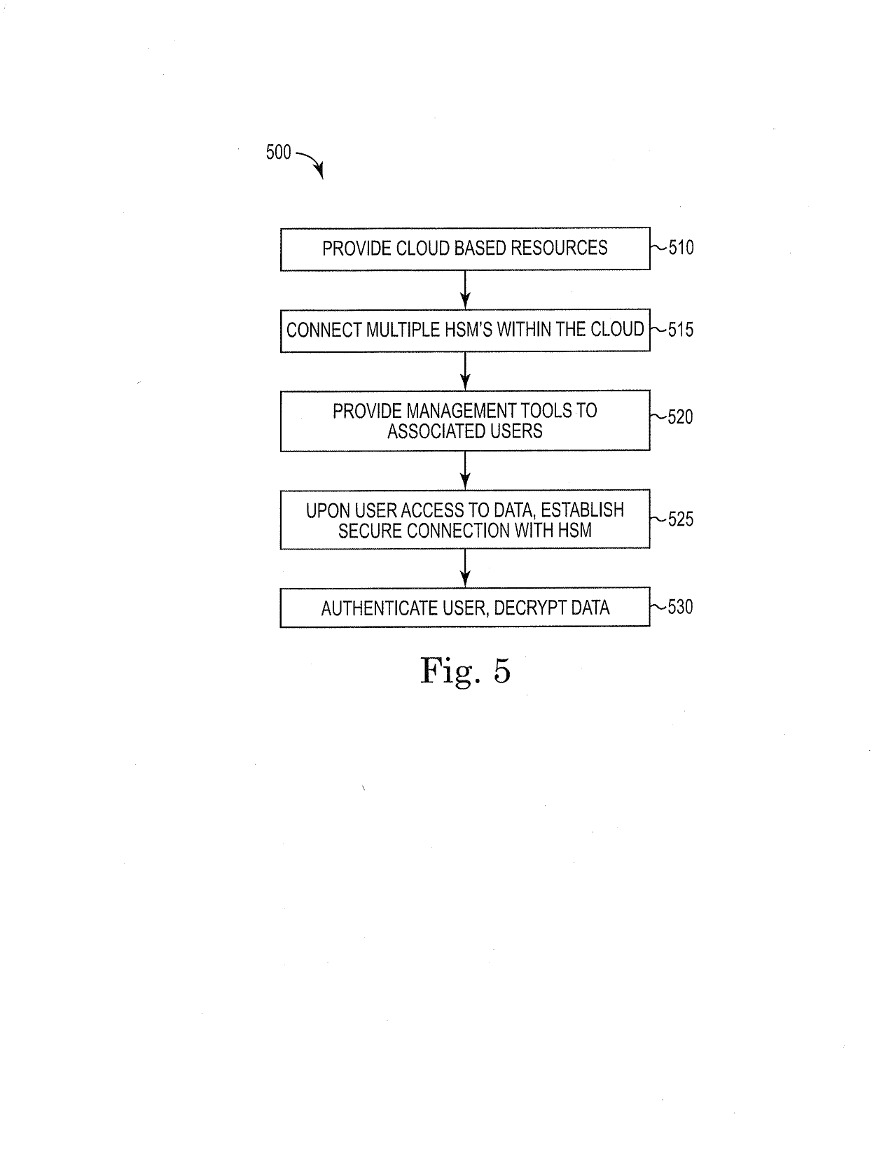

FIG. 5 illustrates an exemplary embodiment of the present disclosure, including an exemplary method 500 for providing cloud-based HSMs. The exemplary method, e.g., at 510, can provide shared resources over a multi-user network to multiple users, e.g., a cloud. These may include disk arrays, processor arrays, servers, memories, etc., configured to provision one or move virtual private networks and/or one or more virtual terminals. The exemplary method, e.g., at 515, can connect multiple HSMs to the shared resources. Each HSM may have one or more users associated with it, and each HSM may be associated with an organization (which may have multiple HSMs associated with it). The exemplary method, e.g., at 520, can provide management tools to the associated users, and/or administrative users within the same organization as the associated users. This way, regardless of whether the HSMs are connected to the cloud on the organization side or the shared resource (e.g., cloud) side, the end user (or admin user of the end user organization) can be given exclusive control of the HSMs, while the cloud provider can optionally be excluded from the HSMs and being able to configure the HSMs. When a user wants to access data (e.g., encrypted data) from the cloud, a secure connection can be established between a user device, and the cloud hosted HSM, e.g., at 525. The HSM can include keys used to decrypt the user's data, and can act as the sole facilitator of accessing that data, e.g., at 530.

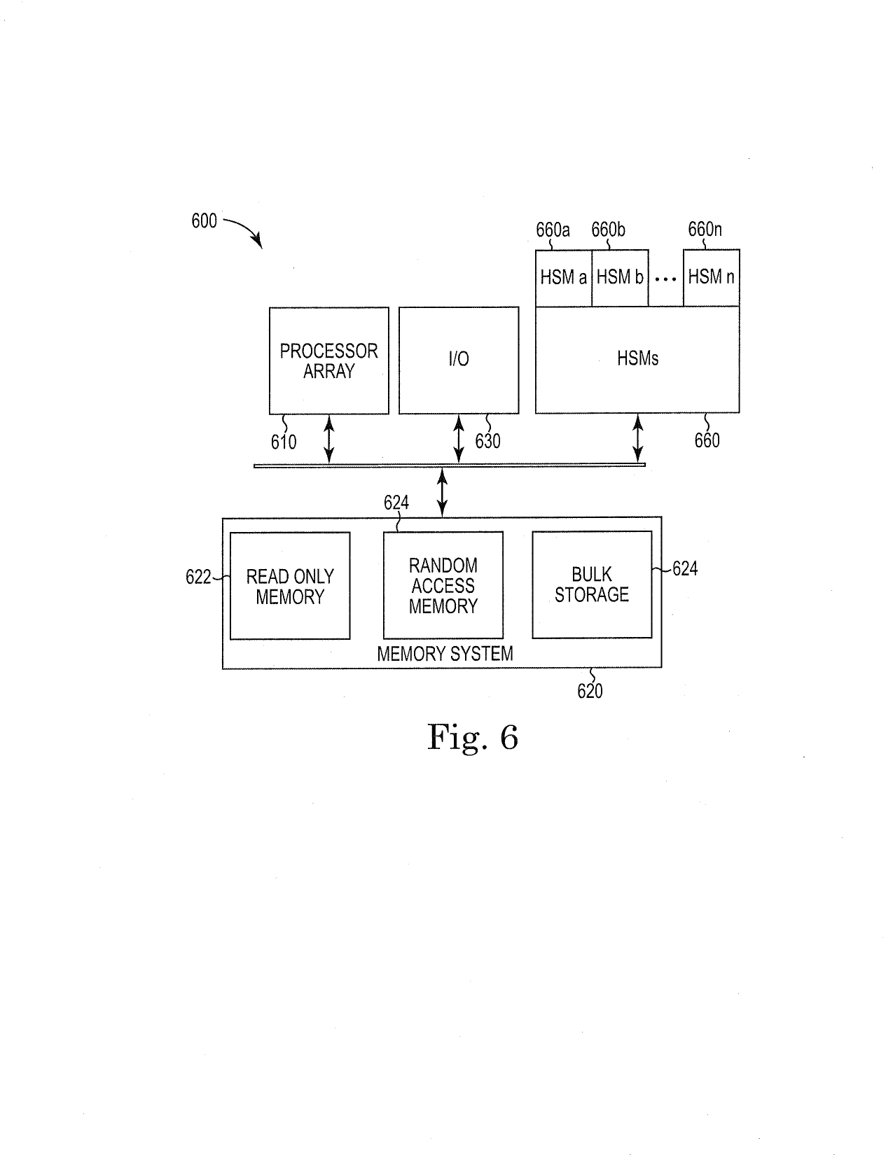

FIG. 6 illustrates an exemplary system 600 configured to execute exemplary procedures, according to other exemplary embodiments of the present invention. The exemplary system 600 can include a processor array 610, an input/output port 630, and various memories 620, including e.g., read only memory 622, random access memory 624, and bulk storage memory 626 (e.g., a disk drive, network drive, database, etc.). Each of these resources can be a single physical object or a set of objects, can be in one location or distributed across a plurality of locations, and can be shared among multiple tenants in a cloud-based recourse paradigm. The exemplary system can also include a plurality of HSMs 660, such as HSM 660a to HSM 660n. The HSMs can be directly connected within system 600, or can be connected to a multi-HSM appliance. HSMs (e.g., 660) can also be in a single physical location or multiple physical locations. Exemplary system 600 can include any number of other devices or data within memory (e.g., 620).

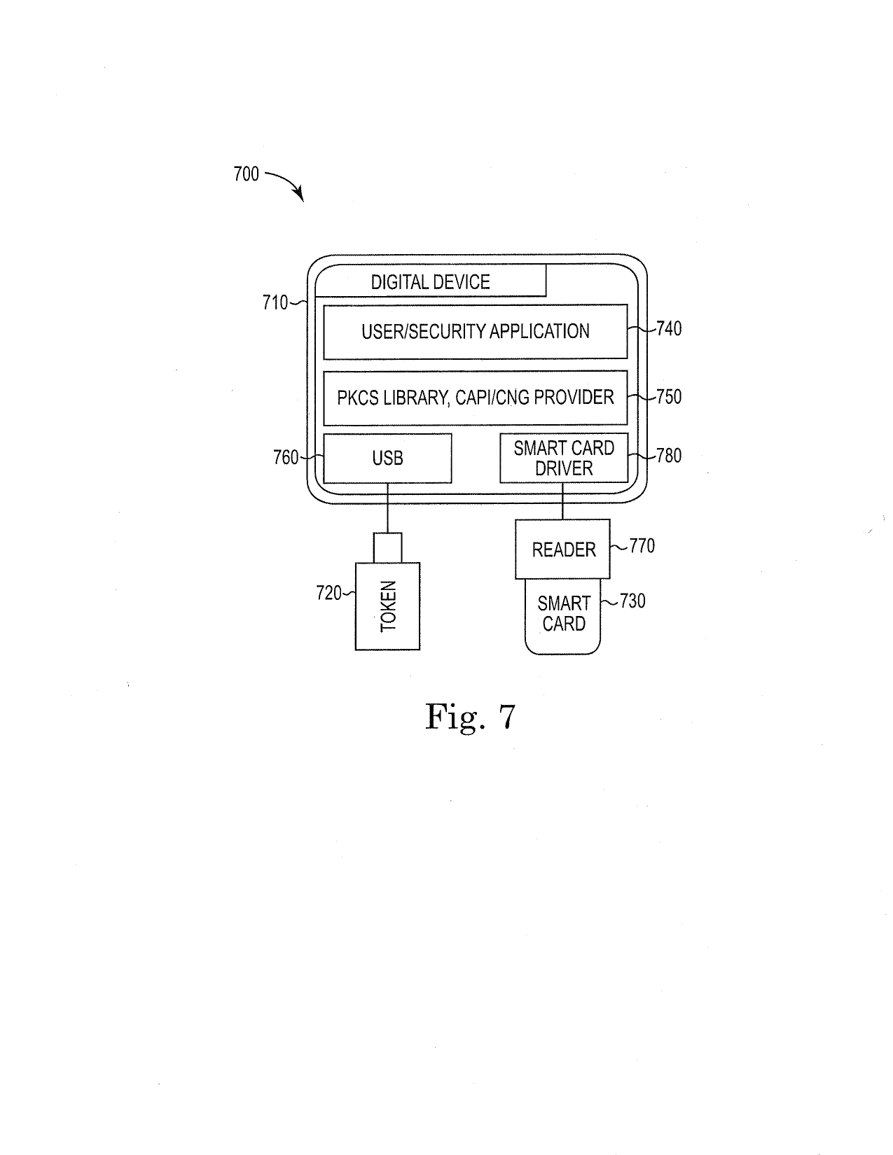

FIG. 7 illustrates a block diagram of a security system 700, utilizing (e.g., public) key cryptography. In this particular example, the system 700 utilizes a computer, mobile phone, tablet device or other digital device 710, which is communicatively coupleable to a PKI token or other security device, for example in the form of a USB token 720 or a smart card or other embedded memory device 730.

The digital device 710 includes memory and processor components for loading and executing a user or security application 740 and a cryptography application program or module 750. The cryptography module 750 may include, for example, one or more of a public key cryptography standard (PKCS) library, a cryptography application programming interface (CAPI or cryptography API) provider, and a cryptography next generation (CNG) provider. The digital device 710 may also include one or more of a USB port or device driver 760 for data communications with the token 720, and a smart card reader (or reader/writer) 770 with a smart card reader or reader/writer driver 780 for data communications with the embedded memory device or smart card 730.

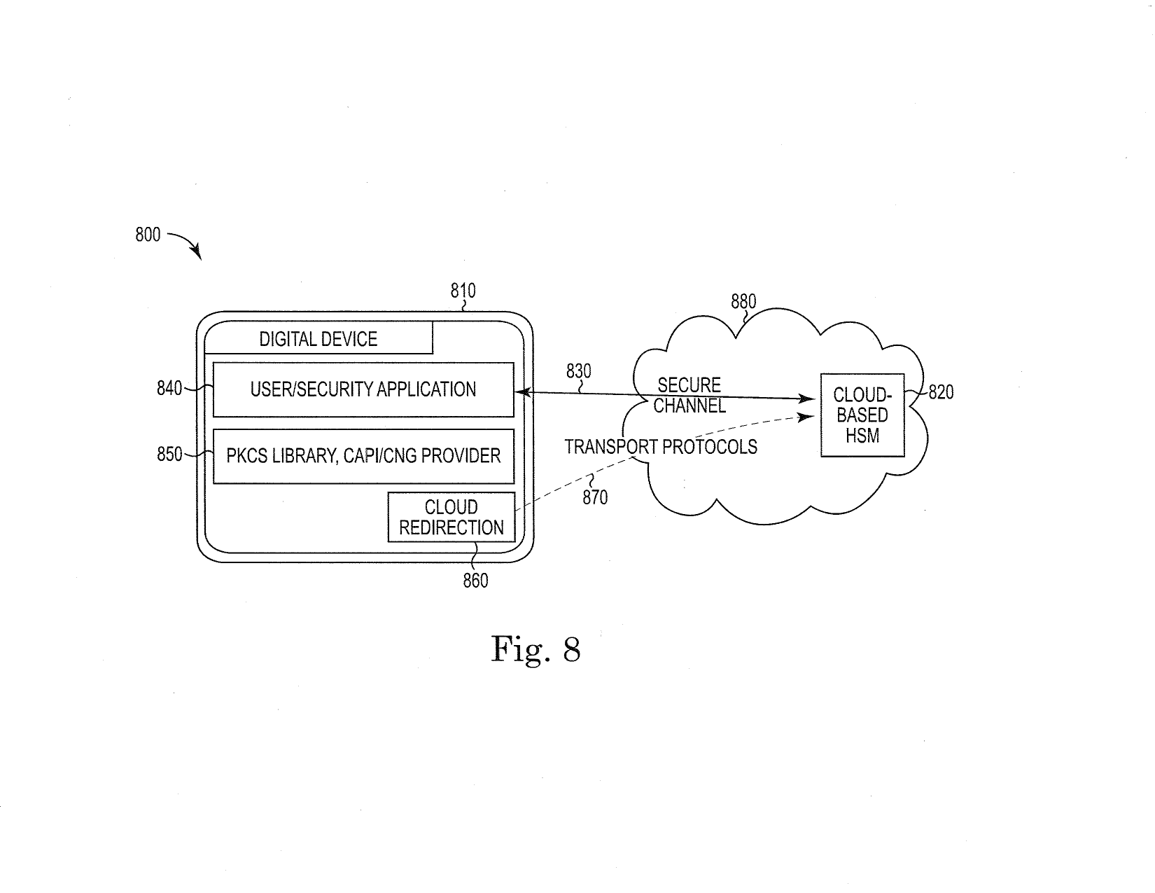

FIG. 8 illustrates a block diagram of a cloud-based security system 800, utilizing a public key token. In this particular example, the system 800 includes a computer, mobile phone, tablet device, or other digital device 810, which is communicatively coupleable to a cloud-based PKI token or hardware security module 820 via a communications channel, for example secure channel 830.

The digital device 810 includes memory and processor components for loading and executing a security application program or module 840 and a cryptography application program or module 850. The cryptographic token interface or module 850 may include one or more of a PKCS library, and a CAPI or CNG provider. The digital device 810 may also include a cloud redirection application, program, module or driver 860 for communication with the cloud-based hardware security module 820, for example utilizing security transport protocols via communication pathway 870, or another communication pathway. Communication pathways 830 and 870 may be provided via a variety of hardware, firmware, software, and wireless communications technology, as described above.

FIGS. 7 and 8 illustrate systems and methods for using a cloud-based hardware security module 820 as a PKI token, for example to perform functions similar or substantially equivalent to a “local” PKI token 720 or 730. As shown in the figures, user and security applications 740 and 840 that need PKI and other security or encryption services may be transparently redirected to the cloud-based token 820, or communicate with a local token device 720 or 730, for example using redirection driver module or application interface 860 in place of one or more USB or smart card port/driver or interface components 760 and 780.

For example, where one device 710 may include one or more ports, interfaces, or drivers 720 or 730 for communicative coupling to a PKI or security token in the form of a USB security module 720 or embedded memory device 730, another device 810 may lack such a port or interface. In such an application, redirection module, driver or interface 860 may be provided to redirect the communicative coupling from a physical port or interface 760 or 780, to cloud-based hardware security module or token 820, operating in cloud environment 880, remote from user device 810 over the multi-user network supporting communication channels 830 and 870. Alternatively, redirection module, driver or interface 860 may redirect secure channel 830 from port or interface (or driver) 760 or 780 to cloud-based hardware security module or token 820.

Redirection sets up a mutually authenticated secure channel of communication 870 between an application 840 (e.g., a user application running on digital device 810) and the cloud-based PKI token or other cloud-based hardware security module 820, such that the security level and process are similar to having a (e.g., local) security device or token 720 or 730 directly coupled or plugged directly into the local system or digital device 710. Standard cryptographic token interfaces or modules 850 may be used, such as a PKCS library, a CAPI or CNG provider, or another cryptographic implementation, a combination thereof.

PKI tokens and hardware security modules 720, 730 and 820 may be used to provide a secure store for cryptographic keys, and as a secure environment to perform critical security processes such as private key operations. PKI tokens and hardware security modules 720, 730 and 820 may also be used in (e.g., user and security) applications 740 and 840 (or 140), such as workstation logins, remote access and VPN logins, email and document signing, email and document encryption, and certificate authentication to websites and servers, including secure socket layer (SSL) websites.

“Local” PKI tokens 720 and 730 may also be directly connected to a computer or other digital device 710, for example through interfaces such as USB port or driver 760 and smart card port or driver (interface) 780. Newer (e.g. portable) digital devices 710 and 810, however, such as smart phones and tablet computer devices (or personal digital assistants or media player devices, including implementations of client device or platform 110 or 410, above), may or may not have the physical interfaces (e.g., 760 and 780) for connecting to existing PKI tokens 720 and 730. Thus, redirection may be substantially transparent, in that application 840 may run without any modification on device 810, which lacks one or more hardware interfaces or ports 760 and 780, or at least without substantial modification as to the communicative coupling, as compared to application 740 running on device 710, which does have one or more hardware interfaces or ports 760 and 780 for communicative coupling to “local” hardware security modules, for example in the form of a USB token 720 or smart card 730.

Because “local” PKI tokens 720 and 730 are typically in the possession of an employee or other user, they may be lost or forgotten, requiring replacement and increased costs for help desk personnel and security follow-up. “Local” PKI tokens 720 and 730 can also be used to access systems and services even after an employer or other organization wants to disable access to the employee/user. While the (e.g., former) employee or user is still in possession of the token 720 or 730, the organization must instead attempt to disable the user's access to systems, for example by deleting or disabling one or more user accounts. The organization may not, however, be able to access the user or employee's computer (e.g. a PC) or other digital device 710 (e.g., a mobile phone, laptop, tablet, or other portable device), if device 710 is also in the possession of the employee/user, along with one or more local security tokens 720 or 730.

Cloud-based redirection driver module or application interface 860 allows for new or existing tokens 720 or 730 to be utilized as cloud-based security tokens or hardware security modules 820, including uses with both older and newer digital devices 710 and 810 (or device 110 or platform 410), which may or may not support physical communication interfaces for local token communications. Thus, cloud redirection driver module or application interface 860 may transparently redirect user and security applications 740 and 840 (or 140) to cloud-based (remote) implementations of token 820, rather than communicating with a local token device 720 or 730, using one or more USB and smart card ports or drivers (interfaces) 760 and 780.

Employees and other users cannot easily lose or forget cloud-based hardware security modules 820 and other cloud-based implementations of formerly “local” PKI devices or security tokens 720 and 730. In addition, access to systems and services can also be quickly or even instantly revoked or de-provisioned, for example by revoking a cloud-based PKI token (or HSM) 820, or revoking user access thereto, where the cloud-based HSM or token 820 operates in the delocalized multi-user network-based (e.g., Internet-based or Internet-connected) cloud environment 880.

In some embodiments, revocation or de-provisioning may also prevent access to systems that are in the possession of the employee or other user, for example a mobile phone or other portable digital device 710 or 810 (or device 110 or platform 410). In addition, existing applications 740 can be ported to newer devices 810, without necessarily changing the software architecture, since redirection to the cloud-based token or hardware security module 820 may be transparent, utilizing a cloud redirection module 860 in place of local hardware connections such as USB and smart card reader/driver (or interface) components 760 and 780.

With the cloud-based PKI token (or hardware security module) 820, the same PKI (and other) security or encryption functions are delivered to the applications 140, 740 and 840, as in other designs. However, the suitable types of platforms can also include devices 110, 410, and 810, which do not necessarily have the same traditional hardware connections, such as USB or smart card port/driver/reader or interface components 760 and 780, as described for device 710 of FIG. 7. User authentication to local tokens 720 and 730 may also be redirected to the cloud-based token 120 or 820, located in and operating in cloud environment 180 or 880, remote from one or more devices 110, 410, 710, and 810, so that the user need not necessarily carry a physical device that can be lost or stolen, or forgotten or left in one location, when needed in another. In addition, administrators, administrative users, and others with administrative privileges can also quickly or even instantly revoke cloud-based tokens 120 and 820, since they are equally accessible to the administrative users though the cloud environments 180 and 880.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processor, microprocessor, mini, macro, mainframe, etc., including a plurality and/or combination thereof. In addition, certain terms used in the present disclosure, including the specification, drawings and numbered paragraphs thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A system for cloud-based hardware security modules, comprising:
a physical security device with a processor configured to:
create a secure connection to a user device across a multi-user network; and
decrypt data accessed by the user device over the multi-user network.

2. The system of claim 1, wherein the secure connection is independent of any transport protocol.

3. The system of claim 1, wherein the physical security device includes a connector of a first type configured to connect to a reciprocal input port of the first type, and wherein the user device does not include an input port of the first type.

4. The system of claim 3, wherein the user device comprises a redirection module for transparent redirection of the secure connection from the input port of the first type to the physical security device, over the multi-user network.

5. The system of claim 4, wherein the first type is a Universal Serial Bus (USB).

6. The system of claim 1, wherein the physical security device is associated with multiple users.

7. The system of claim 1, further comprising an appliance configured to receive a plurality of the physical security devices.

8. The system of claim 7, wherein each of the plurality of physical security devices is associated with multiple users, each processor being configured to create multiple secure connections, including at least one secure connection per user.

9. The system of claim 8, wherein each physical security device is associated with only one organization and the multiple users associated with a particular physical security device are all within the only one organization.

10. The system of claim 9, wherein a plurality of the physical security devices are associated with a single organization.

11. The system of claim 1, wherein the physical security device operates in a cloud environment, remote from the user device over the multi-user network.

12. The system of claim 11, wherein the processor is configured to de-provision user access to the user device by revoking the physical security device.

13. A method for providing hardware security modules over a multi-user network, comprising:
providing shared resources over a multi-user network to multiple users;
connecting multiple hardware security modules to the shared resources, wherein each hardware security module is associated with at least one user;
establishing a secure connection over the multi-user network between the at least one user and an associated hardware security module; and
providing encrypted data to the at least one user, wherein the encrypted data can only be decrypted with one or more keys stored on the associated hardware security module.

14. The method of claim 13, wherein the shared resources are shared among multiple organizations requiring strict data access separation such that each organization can only access data associated with that particular organization.

15. The method of claim 14, wherein each hardware security module is associated with only one organization and at least one user within the only one organization.

16. The method of claim 15, wherein a plurality of the multiple hardware security modules are associated with the only one organization.

17. The method of claim 13, wherein at least one of the multiple hardware security modules is associated with multiple users.

18. The method of claim 13, further comprising:
providing management tools to a user associated with a particular one of the multiple hardware security modules to directly configure the particular hardware security module.

19. The method of claim 13, wherein connecting multiple hardware security modules includes connecting a security appliance to the shared resources, wherein the security appliance is configured to receive and connect to the multiple hardware security modules.

20. The method of claim 13, further comprising the at least one user running an application on a user digital device.

21. The method of claim 20, further comprising:
providing the one or more keys to the application via the secure connection over the multi-user network; and
decrypting the encrypted data, using the one or more keys.

22. The method of claim 20, wherein the user digital device lacks a hardware interface for communicative coupling with the hardware security module, absent the multi-user network.

23. The method of claim 22, further comprising operating the associated hardware security module in a cloud environment, remote from the at least one user over the multi-user network.

24. The method of claim 23, further comprising redirecting the communicative coupling from the hardware interface to the associated hardware security module operating in the cloud environment.

25. The method of claim 24, wherein redirecting the communicative coupling is performed transparently, such that the application does not require modification as compared to an implementation on a user digital device having the hardware interface.

26. The method of claim 23, further comprising revoking access by the at least one user to the associated hardware security device operating in the cloud environment.

27. The method of claim 23, further comprising revoking access by the at least one user to the user digital device by operation of the associated hardware security device in the cloud environment.

28. A method for managing data in a non-volatile memory system, the method comprising:
providing shared resources over a multi-user network to multiple users;
connecting multiple hardware security modules to the shared resources, wherein each hardware security module is associated with at least one user;
establishing a secure connection over the multi-user network between the at least one user and an associated hardware security module; and
providing encrypted data to the at least one user, wherein the data can be decrypted with one or more keys stored on the associated hardware security module.

29. The method of claim 28, further comprising revoking user access to the one or more keys by operation of the hardware security module in a cloud environment, remote from the at least one user over the multi-user network

30. The method of claim 29, further comprising preventing operative access of the at least one user to the digital device by the revocation of user access to the hardware security module.

31. The method of claim 28, further comprising:
sharing the one or more keys over the secure connection with an application running on a digital device associated with the at least one user; and
decrypting the encrypted data, using the one or more keys.

32. The method of claim 31, wherein the digital device lacks a hardware interface for communicative coupling with the hardware security module, absent the secure connection over the multi-user network.

33. The method of claim 32, further comprising transparently redirecting the communicative coupling from the hardware interface to the associated hardware security module operating in the cloud environment.

34. The method of claim 33, wherein the application runs without modification as compared to an implementation on a user digital device having the hardware interface.

35. A non-volatile computer readable storage medium having a program embedded thereon, the program executable by a processor to perform the method of claim 28.
